(19) United States
(12) Patent Application Publication
(10) Pub. No.: US 2008/0278377 A1
(43) Pub. Date: Nov. 13, 2008

(54) MULTI-BAND ANTENNA

(76) Inventor: Scott LaDell VANCE, Staffanstorp (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/757,478

(22) Filed: Jun. 4, 2007

Related U.S. Application Data
(60) Provisional application No. 60/916,863, filed on May 9, 2007.

(51) Int. Cl. H01Q 9/04

(52) U.S. Cl. 343/700 MS

(57) ABSTRACT

A monopole antenna having multiple resonances includes a feed point; a meander element; and an electrically conductive element that couples the feed point to the meander element, the electrically conductive element including at least a portion with a width that is greater than the width of the meander element.

### RELATED APPLICATION DATA

The present application claims the benefit of U.S. Provisional Application Ser. No. 60/916,863, filed May 9, 2007, the disclosure of which is herein incorporated by reference in its entirety.

### TECHNICAL FIELD OF THE INVENTION

The present invention relates generally to portable and stationary electronic devices such as mobile phones, and more particularly to electronic devices having an antenna for carrying out mobile communications.

### DESCRIPTION OF THE RELATED ART

Portable electronic devices such as mobile phones have been popular for years and yet only continue to increase in popularity. Traditionally, mobile phones had been used strictly for conventional voice communications. However, as technology has developed mobile phones are now capable not only of conventional voice communications, but also are capable of data communications, video transfer, media reproduction, commercial radio reception, etc. More and more, a user having a single electronic device is able to perform a variety of different functions.

As technology advances in the field of mobile phones and other electronic devices, the need for broadband data transmission and reception continues to increase. Consequently, the demands on the radio portion of the electronic device also increase. At the same time, however, there is a constant push for miniaturization of the electronic devices to satisfy the convenience and desires of consumers. The need for broader bandwidth coupled with reduced size creates problems insofar as providing an antenna in the electronic device that performs satisfactorily. Generally speaking, the smaller the size of the antenna, the lower the antenna performance at the various frequency bands (e.g., 880 to 960 megahertz (MHz) and 1.71 to 2.17 gigahertz (GHz)).

In view of the aforementioned shortcomings associated with conventional electronic devices, there is a strong need in the art for an electronic device having an antenna configuration that provides both small size, and good low and high band performance and increased bandwidth.

### SUMMARY

According to an aspect of the invention, a monopole antenna having multiple resonances includes a feed point; a meander element; and an electrically conductive element that couples the feed point to the meander element, the electrically conductive element including at least a portion with a width that is greater than the width of the meander element.

According to another aspect, the width of the electrically conductive element is at least 1.5 times the width of the meander element.

In accordance with another aspect, the width of the electrically conductive element is at least 2.0 times the width of the meander element.

In accordance with still another aspect, a branch element is included along at least one of the feed point and the electrically conductive element, the branch element being coupled to ground.

According to another aspect, the branch element is less than one third the width of the electrically conductive element.

In yet another aspect, the branch element is between one-third and one-fiftieth the width of the electrically conductive element.

In still another aspect, the branch element is coupled at one end to the electrically conductive element.

According to another aspect, an additional branch element is provided and is positioned between the branch element and the at least one of the feed point and the electrically conductive element, the additional branch element being coupled to either the ground point or the feed point.

In still another aspect, the additional branch element is coupled to the ground point.

According to another aspect, the additional branch element is coupled to the feed point.

In accordance with another aspect, an additional branch element is electrically coupled to the branch element, and the additional branch element is positioned on a side of the branch element opposite the side of the electrically conductive element.

According to another aspect, at least part of the electrically conductive element is located sufficiently close to the feed point such that capacitive coupling occurs between the two, thereby further enhancing bandwidth.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1A is a diagram of a multi-band antenna in accordance with an embodiment of the present invention;

FIG. 1B is a gain versus frequency plot comparing the antenna of FIG. 1A with a conventional antenna;

FIG. 2A is a diagram of a multi-band antenna in accordance with another embodiment of the present invention;

FIG. 2B is a gain versus frequency plot comparing the antenna of FIG. 1A and the antenna of FIG. 2A;

FIG. 3 is a diagram of a multi-band antenna in accordance with another embodiment of the present invention;

FIG. 4A is a diagram of a multi-band antenna according to another example of the embodiment of FIG. 2, without matching;

FIG. 4B is a VSWR plot and Smith chart for the multi-band antenna of FIG. 4A;

FIG. 5A is a diagram of a multi-band antenna of FIG. 4A, with matching;

FIG. 5B is a VSWR plot and Smith chart for the multi-band antenna of FIG. 5A;

FIG. 6 is a VSWR plot and Smith chart for the multi-band antenna of FIG. 3, with matching;

FIG. 7A is a diagram of a multi-band antenna according to an alternate embodiment;

FIG. 7B is a diagram of a multi-band antenna according to another alternate embodiment;

FIG. 7C is a diagram of a multi-band antenna according to still another alternate embodiment;

FIG. 7D is a diagram of a multi-band antenna according to yet another alternate embodiment;

FIG. 7E is a diagram of a multi-band antenna according to another alternate embodiment; and

FIG. 8 is a perspective view of the antenna of FIG. 7A, illustrating an exemplary application of the antenna on a physical carrier.

### DETAILED DESCRIPTION OF EMBODIMENTS

The present invention will now be described in detail with reference to the figures, in which like elements are referred to by like reference labels throughout.

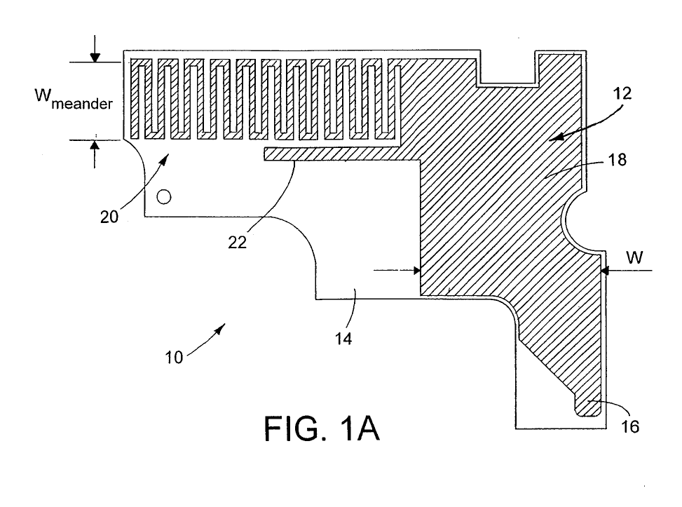

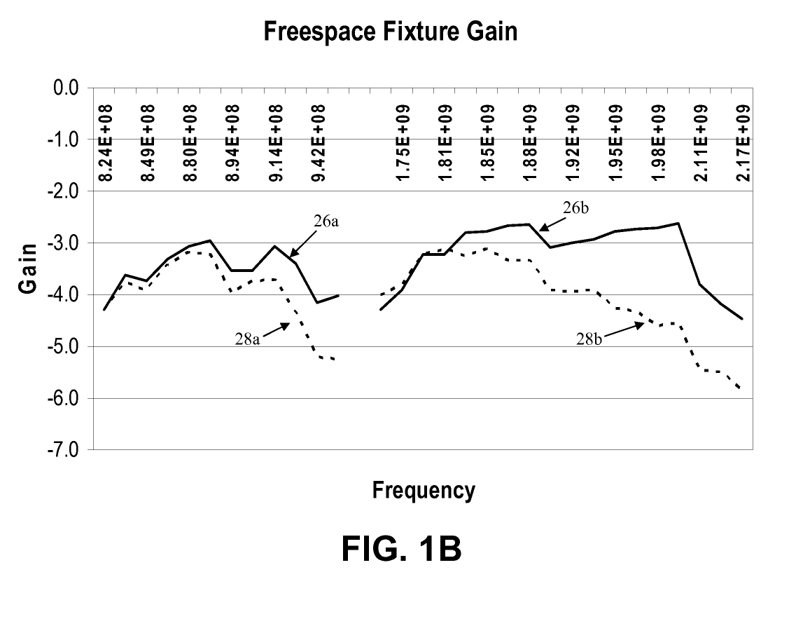

Referring initially to FIG. 1A, an antenna 10 in accordance with a first embodiment of the present invention is shown. The antenna 10 is represented by an electrically conductive pattern 12 formed on a substrate 14. The substrate 14 may be made of any conventional material used for antennas such as a dielectric substrate. The pattern 12 is made of an electrically conductive material such as copper or the like, and may be formed on the substrate 14 using conventional techniques such as those utilized in microstrip antenna fabrication or the like (e.g., on a printed circuit board substrate 14).

The antenna 10 is a bent monopole antenna having multiple resonances. As is shown in FIG. 1A, the antenna 10 includes a feed point 16, a wide conductive element 18, a meander element 20, and a branch element 22 adjacent the meander element 20. The feed point 16 is coupled to the meander element 20 and branch element 22 by way of the wide conductive element 18, representing a wide feed area. The branch element 22 is parallel to the meander element 20 and extends along approximately one-half the length of the meander element 20 in this example. The branch element 22 serves to lower the frequency of the 3^{rd} harmonic of the antenna 10. For example, the branch element 22 can lower the frequency of the third harmonic in order tune it to the 1710-1990 megahertz (MHz) frequencies. The meander element 20 is tightly meandered for lowering the 3^{rd} harmonic of the primary ¼ wave resonator without significantly impacting the primary ¼ wave resonance. The meander element 20 in combination with the branch element 22 lowers the 3^{rd} harmonic from around 2.4 GHz to 1.7 GHz-2.1 GHz, making this antenna more usable on the commercial wireless spectrum.

The wide conductive element 18 couples the feed point 16 to a proximal end of the meander element 20. The conductive element 18 has a width w that is significantly wider than that found in conventional configurations. In the exemplary embodiment, the width w of the conductive element 18 is approximately twice the meander width w_{meander} of the meander element 20, and twenty-five times the trace width w_{trace} of the meander element 20. More broadly, the width w of the conductive element 18 is preferably greater than the meander width w_{meander}, more preferably greater than 1.5 times, and even more preferably greater than two times the meander width w_{meander}. Moreover, the width w of the conductive element 18 is preferably at least ten times the trace width w_{trace} of the meander element 20.

The combination of the wide feed section, e.g., the conductive element 18, near the feed point at the beginning or proximal end of the meander element 20, and the high-impedance presented by the tight meander element 20, provides improved high-band bandwidth. Further, preferably at least part of the wide conductive element 18 is located sufficiently close to the feed point 16, e.g., as shown, such that capacitive coupling occurs between the two, thereby further enhancing bandwidth.

Referring to FIG. 1B, gain plots 26a and 26b illustrate the performance of the antenna 10 of FIG. 1A. Gain plots 28a and 28b illustrate the performance of a conventional antenna (not shown) having a trace of conventional width coupling the feedpoint to the meander element, designed in conjunction with a grounded parasitic branch (such as is outlined in US Published Patent Application No. 2005/0110692). As is noted, the bandwidth of the antenna is substantially improved at the higher end. Furthermore, the gain is improved over almost the entire band, particularly in the higher frequencies.

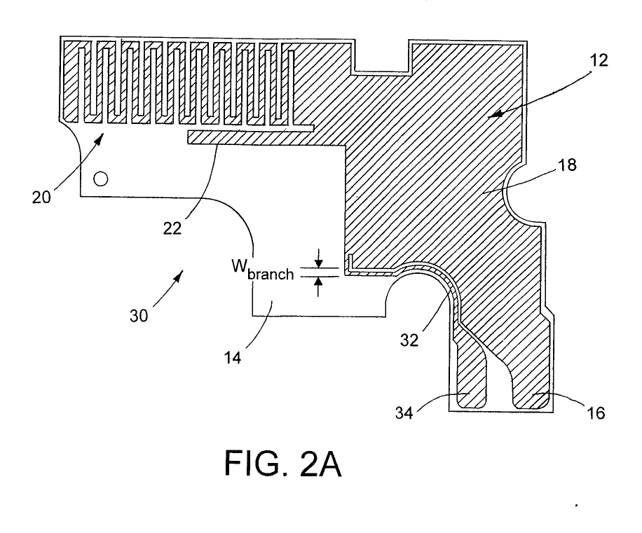

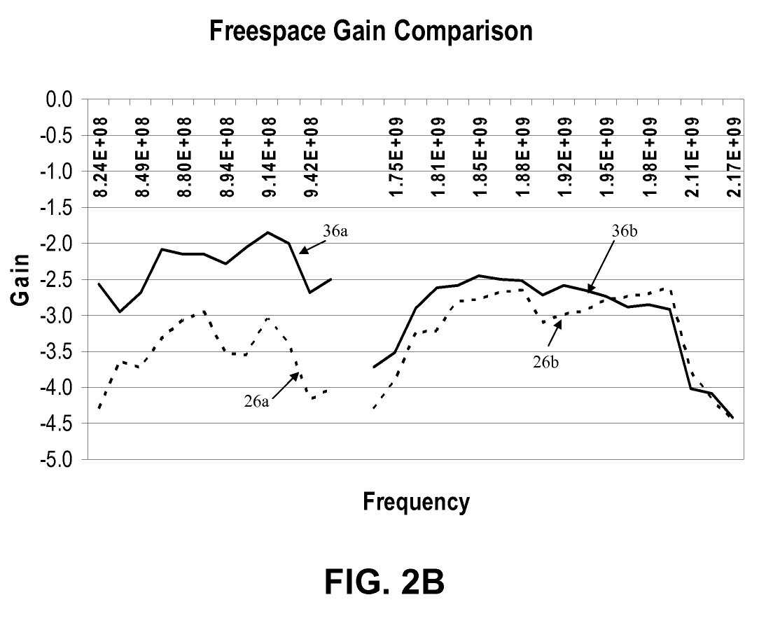

FIG. 2A illustrates an antenna 30 in accordance with another embodiment of the present invention. Like the embodiment of FIG. 1A, the antenna 30 includes a feed point 16, a wide conductive element 18, a meander element 20, and a branch element 22 adjacent the meander element 20. Additionally, however, the antenna 30 includes an additional branch element 32 coupled to a ground point 34. The branch element 32 is provided primarily for impedance matching as is discussed in more detail below. The branch element 32 preferably has a width w_{branch} that is substantially more narrow than the width w of the wide conductive element 18 coupling the feed point 16 to the meander element 20. This enables the antenna 30 to minimize the width of the ground point 34 and branch element 32, while maximizing the width of the feed point 16 and the wide conductive element 18.

In the exemplary embodiment, the width w_{branch} of the branch element 32 is approximately 1/50^{th} the width w of the wide conductive element 18. More broadly, however, the width w_{branch} of the branch element 32 is preferably less than ⅓^{rd} of the width w of the wide conductive element 18. As a result, the branch element 32 serves primarily for impedance matching. In the exemplary embodiment, the width w_{branch} of the branch element (32) is increased near the end of this branch (e.g., at ground point 34) in order to facilitate a contact pad which is in turn coupled to the printed circuit board substrate 14.

FIG. 2B is a gain comparison between the antenna 10 in FIG. 1A and the antenna 30 of FIG. 2A. Again, gain plots 26a and 26b illustrate the performance of the antenna 10 of FIG. 1A. Gain plots 36a and 36b illustrate the performance of the antenna 30 of FIG. 2A. As is shown, the provision of the narrow branch element 32 ground allows for the impedance matching of the antenna to be improved significantly (e.g., by approximately 1 decibel (db)), particularly at the lower end.

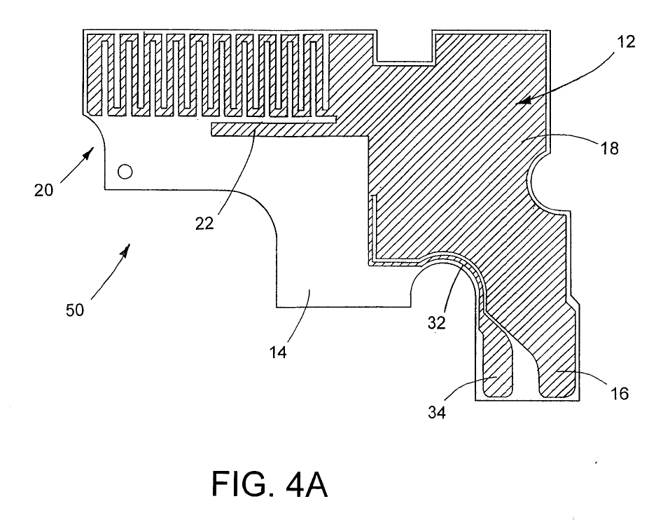

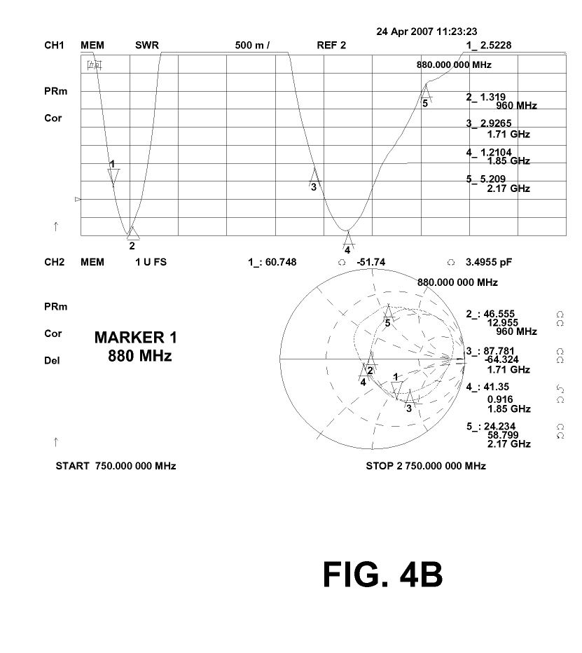

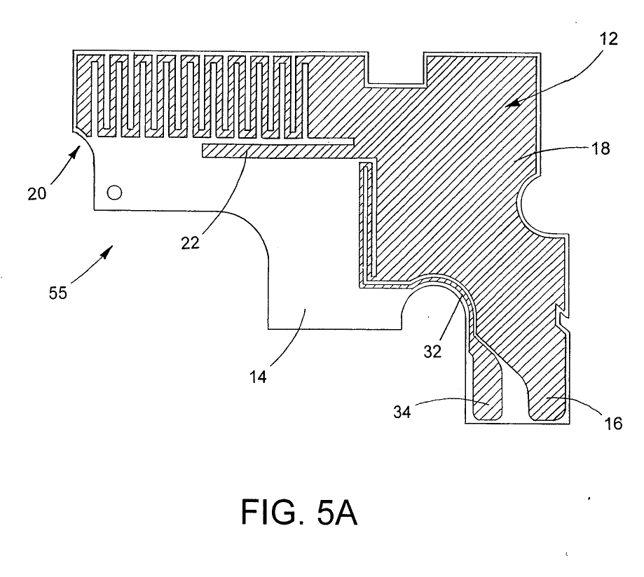

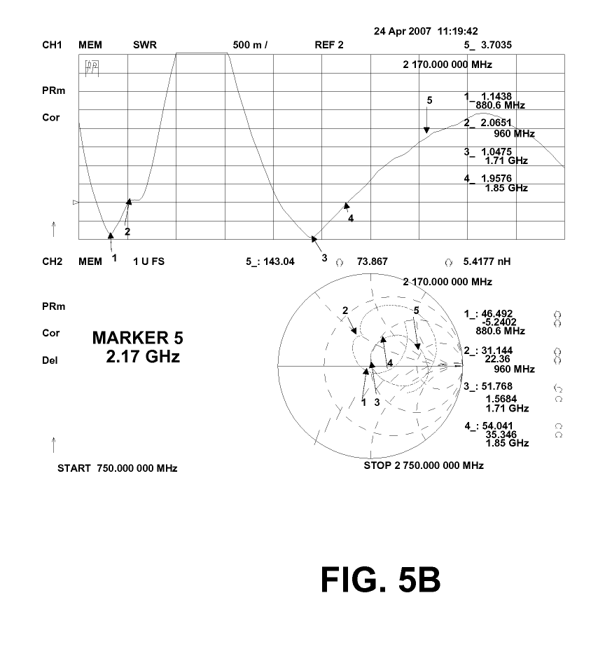

The addition of the ground point 34 and the narrow branch element 32 provide the following benefits: (i) the risk for electrostatic discharge (ESD) from the antenna into the radio or other device utilizing the antenna is minimized as ESD has a direct patch to ground; (ii) the low-band bandwidth and gain is improved as noted in FIG. 2B; (iii) one can tune the impedance of the low and high-bands easily through the length of the slit between the feed (e.g., wide conductive element 18) and ground (e.g., narrow branch element 32), as is discussed in more detail below with respect to FIGS. 4A-4B and 5A-5B; and (iv) the need for matching circuitry on the substrate 14 is reduced or eliminated in that the antenna 30 may be easily self-matched.

Generally speaking, tuning of the antenna 30 may be accomplished as follows: (i) the base antenna is constructed with the feed point 16, wide conductive element 18, meander element 20 and branch element 22. The meander element 20 is adjusted to adjust the low-band tuning of the antenna 30. The “tuning stub” presented by the branch element 22 is adjusted to further adjust the high-band frequencies. The slit length between the feed (e.g., wide conductive element 18) and ground (e.g., narrow branch element 32) is adjusted to provide the best impedance relative to the desired impedance (e.g., 50 ohms). It has been found that the slit works best when placed as close as possible to the edges of the wide conductive element 18. The line width and spacing is small for best results (e.g., about 0.3 mm). Smaller widths may be possible with some manufacturing techniques, but if the trace is too small, ohmic losses may increase and manufacturing tolerances may increase. Therefore, for practical purposes, a width of between about 0.2 mm and 1 mm may be preferred.

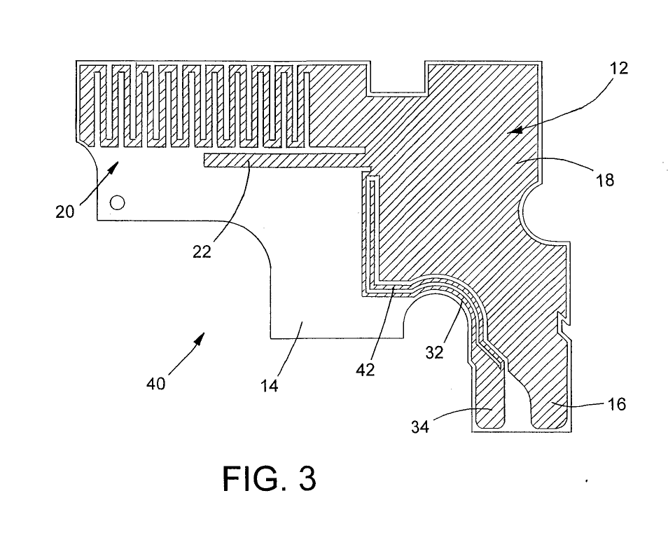

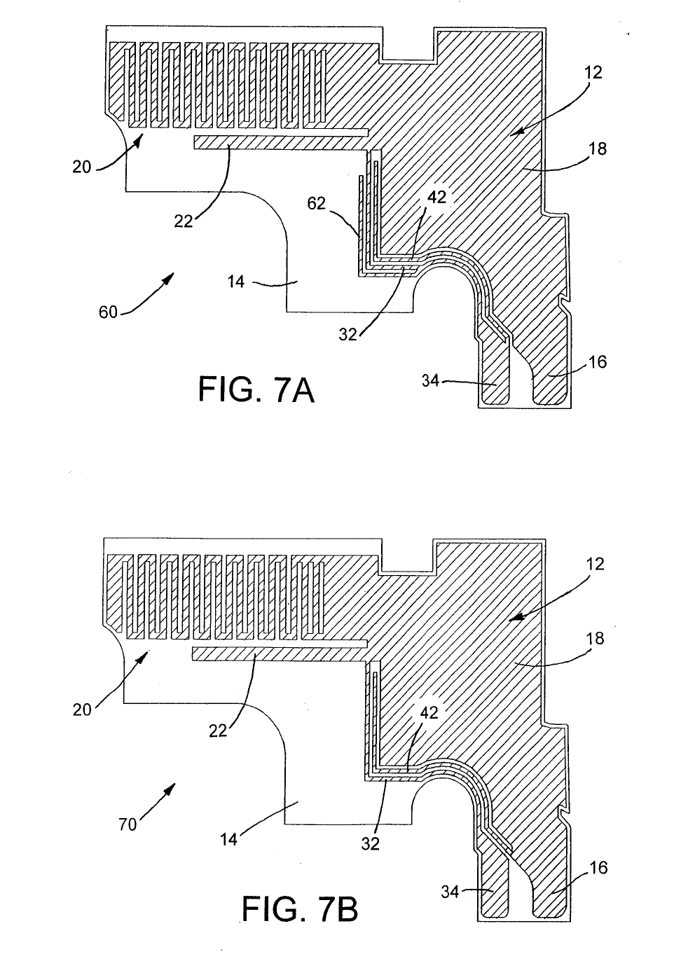

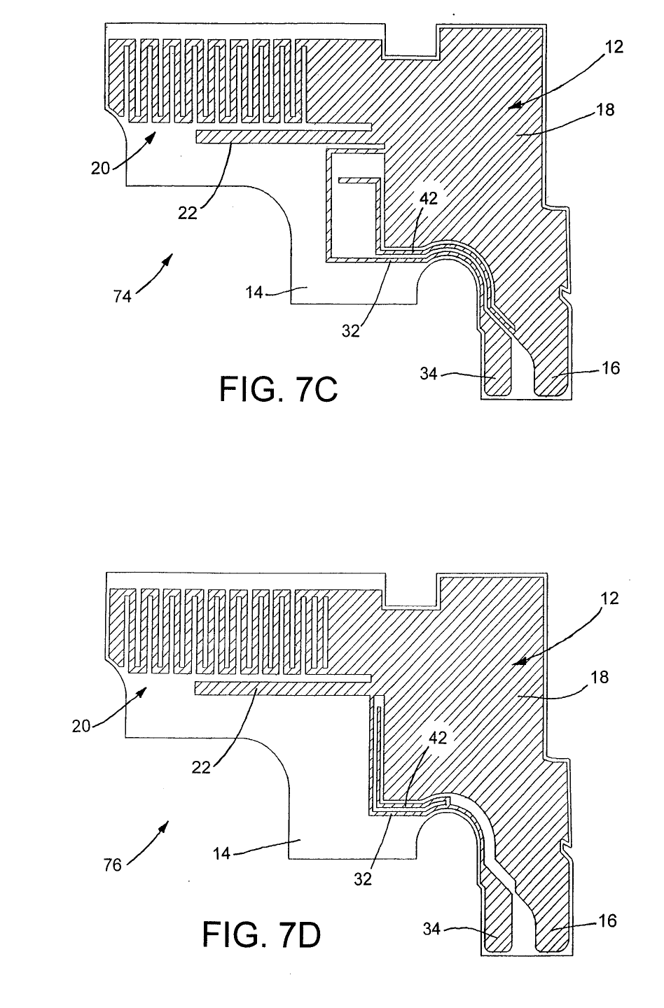

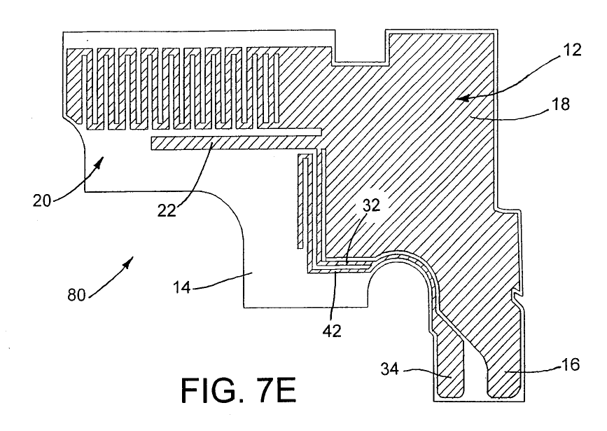

Referring now to FIG. 3, another embodiment of the invention is represented as antenna 40. Like the embodiment of FIG. 2A, the antenna 40 includes a feed point 16, a wide conductive element 18, a meander element 20, a branch element 22, additional branch element 32, and ground point 34. Furthermore, however, an additional branch 42 is included in this embodiment. The additional branch 42 may be placed between the feed side and the ground side of the antenna 40, and may be attached to either the feed or the ground side of the antenna 40 to create another resonance. As is shown in FIG. 3, the additional branch 42 is located between the ground side (e.g., branch element 32 coupled to ground) and the feed side (e.g., feed point 16 and wide conductive element 18). The additional branch 42 is attached to the ground point 34. In another embodiment as discussed below with respect to FIGS. 7B-7D, the additional branch 42 may be attached to the feed side of the antenna.

When the additional branch 42 is attached to the feed side, the frequency of the extra resonance created by branch 42 on antenna 40 will tend to be shifted upwards. Accordingly, a longer branch 42 will typically be necessary to tune the extra resonance of antenna 40 to the desired frequency.

The additional branch 42 preferably is relatively thin to allow for maximum bandwidth enhancement without gain degradation. For example, the width of the additional branch 42 is preferably ⅓^{rd} or less compared to the width of the ground point 34 or feed point 16 to which it is attached. However, as known to those skilled in the art, this extra branch (42) may be made wider which may provide bandwidth advantages in certain applications.

FIG. 4A illustrates an antenna 50 of the type described above in relation to FIG. 2A. Note the slit between the branch element 32 and the wide conductive element 18 extends approximately ⅓^{rd} the distance to the top of the meander element 20. FIG. 4B represents the voltage standing wave ratio (VSWR) and Smith chart for the antenna shown in FIG. 4B. FIG. 5A represents an antenna 55 similar to that of antenna 50, except tuned to improve the VSWR and impedance matching as illustrated in FIG. 5B. Such tuning includes lengthening the slit between the branch element 32 and the wide conductive element 18 so as to extend further upward and then fold back down as shown in FIG. 5A.

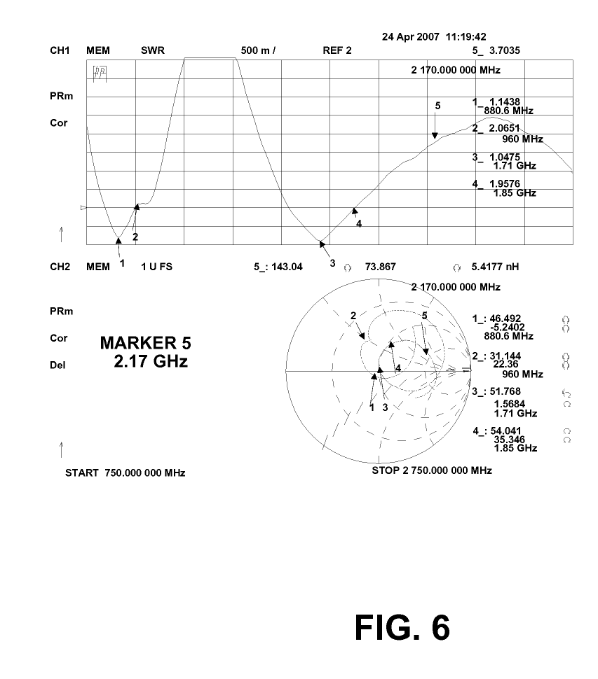

FIG. 6 is a VSWR and Smith chart for the antenna 40 shown in FIG. 3. Matched appropriately as shown, the antenna 40 has improved response in the higher frequency band (e.g., compare FIG. 5B with FIG. 6).

An additional branch placed adjacent to the widened radiating area (e.g., wide conductive area 18) and connected to either the feed point 16 or the grounded branch element 32, which, when tuned to a certain length, creates a resonance which may be placed adjacent to the high-band resonance in order to improve the resonance bandwidth of the high-band. Additionally, this additional branch may be tuned to other frequencies either above or below the said high-band resonance. Furthermore, it is possible to use multiple branches attached either to the said impedance matching grounded branch or the radiating feed branch to create yet another resonance which may be used either to extend bandwidth or to change the radiating characteristics in yet another frequency bandwidth.

For example, FIG. 7A illustrates an antenna 60 in accordance with another embodiment of the invention. In this embodiment, the antenna 60 includes branch element 32 and additional branch 42 as described above in relation to the embodiment of FIG. 3. In addition, however, the antenna 60 includes an additional branch 62. Branch 42 and branch 62 represent two separate branches in the pattern 12 which can be tuned for two separate frequencies. For example, branch 42 is tuned to about 2.1 GHz to improve high-band bandwidth. Branch 62 is tuned to 3.4 GHz and effectively reduces radiated harmonics. In other words, the antenna 60 may have multiple branches tuned to multiple frequencies without departing from the scope of the invention.

FIG. 7B illustrates an embodiment where an antenna 70 includes the aforementioned additional branch 42 connected to the feed side rather than the ground side. The same additional bandwidth is achieved as compared to the embodiment of FIG. 3. The primary practical difference, as previously noted, is that the extra resonance is tuned higher than when attached to the ground side, so it is necessary to use a longer branch in order to tune this resonator to be resonate in the desired frequency band.

FIG. 7C is a variation of the embodiment of FIG. 7B. In this embodiment, it is shown that in the antenna 74 the branch element 32 and/or additional branch 42 need not be parallel, but can assume various forms without changing the basic properties.

FIG. 7D illustrates an antenna 76 similar to the embodiment of FIG. 3. The embodiment of FIG. 7D illustrates that the branch position for the additional branch 42 need not be adjacent to the feed point 16 or grounding point 34, but can be further up on the element (e.g., approximately ⅓^{rd} the length of branch element 32 from ground point 34. In such embodiment, the length would have to be increased to achieve the same resonance frequency for this branch as will be appreciated.

FIG. 7E illustrates an antenna 80 which again is similar to the embodiment of FIG. 3. In the embodiment of FIG. 7E, however, it is shown that the additional branch 42 in an alternative embodiment can be located on the side of the branch element 32 opposite to the feed side and the wide conductive element 18.

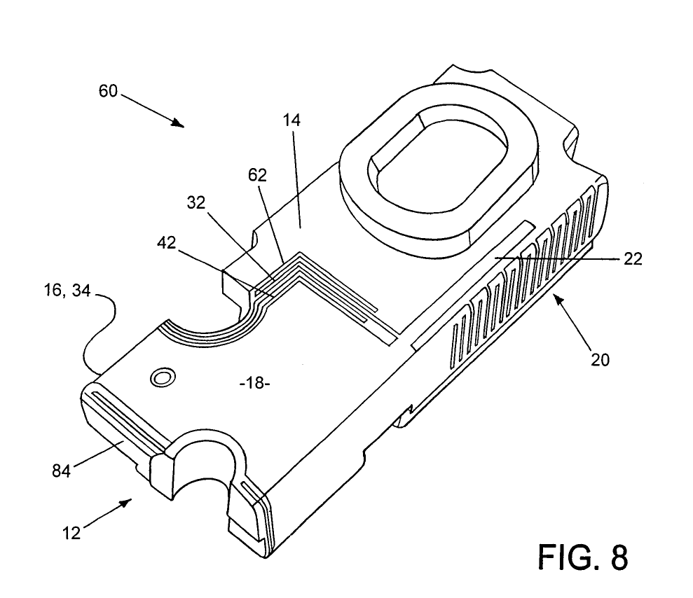

FIG. 8 represents a perspective view of the antenna 60 of FIG. 7A on a physical carrier for inclusion in an electronic device. While FIG. 8 illustrates the embodiment of FIG. 7A, it will be appreciated that any of the above-described embodiments can be similarly applied.

As is shown in FIG. 8, the antenna 60 is mounted on a generally rectangular block substrate 12. In relation to FIG. 7A, the upper portion of the antenna 60, including the meander element 20 and upper portion of the conductive element 18 are wrapped around the upper edge of the substrate 12. The lower portion of the conductive element 18 together with the feed point 16 and ground point 34 are wrapped around a lower edge of the substrate 12. Further, the conductive element 18 includes a tab portion 84 (not shown in the above figures) which wraps around a side edge of the substrate 12 so as to be proximate the feed point 16 wrapped around the lower edge of the substrate 12, thereby providing additional capacitive coupling there between.

The term “electronic device” as referred to herein includes portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A monopole antenna having multiple resonances, comprising:
a feed point;
a meander element; and
an electrically conductive element that couples the feed point to the meander element, the electrically conductive element comprising at least a portion with a width that is greater than the width of the meander element.

2. The monopole antenna of claim 1, wherein the width of the electrically conductive element is at least 1.5 times the width of the meander element.

3. The monopole antenna of claim 2, wherein the width of the electrically conductive element is at least 2.0 times the width of the meander element.

4. The monopole antenna of claim 1, further comprising a branch element along at least one of the feed point and the electrically conductive element, the branch element being coupled to ground.

5. The monopole antenna of claim 4, wherein the branch element is less than one third the width of the electrically conductive element.

6. The monopole antenna of claim 5, wherein the branch element is between one-third and one-fiftieth the width of the electrically conductive element.

7. The monopole antenna of claim 4, wherein the branch element is coupled at one end to the electrically conductive element.

8. The monopole antenna of claim 4, further comprising an additional branch element positioned between the branch element and the at least one of the feed point and the electrically conductive element, the additional branch element being coupled to either the ground point or the feed point.

9. The monopole antenna of claim 8, wherein the additional branch element is coupled to the ground point.

10. The monopole antenna of claim 8, wherein the additional branch element is coupled to the feed point.

11. The monopole antenna of claim 4, further comprising an additional branch element electrically coupled to the branch element, wherein the additional branch element is positioned on a side of the branch element opposite the side of the electrically conductive element.

12. The monopole antenna of claim 1, wherein at least part of the portion of the electrically conductive element is located sufficiently close to the feed point such that capacitive coupling occurs between the two, thereby further enhancing bandwidth.
